(19) United States
(12) Patent Application Publication
(10) Pub. No.: US 2023/0117390 A1
(43) Pub. Date: Apr. 20, 2023

(54) SYSTEM AND METHOD FOR PROACTIVE AND REVERSIBLE MITIGATION OF STORM/HURRICANE/TYPHOON/CYCLONE

(71) Applicant: Frank Bor-Her Chen, Lakeland, FL (US)

(72) Inventor: Frank Bor-Her Chen, Lakeland, FL (US)

(21) Appl. No.: 17/952,858

(22) Filed: Sep. 26, 2022

Related U.S. Application Data
(60) Provisional application No. 63/255,503, filed on Oct. 14, 2021.

(51) Int. Cl. B63B 35/00; B63B 22/00

(52) U.S. Cl. CPC B63B 35/00; B63B 22/00; A01G 15/00

(57) ABSTRACT

A water surface system for mitigation of tropical storms or hurricanes/typhoons/cyclones, the water surface system comprising one or more floating objects capable of minimizing water temperature increase due to sun irradiation and water evaporation and one or more boom-like structures capable of containing the floating objects in a designated area. For effective mitigation, the designated areas are the origins and paths historically most often occurred of storms/hurricanes/typhoons/cyclones.

### CROSS REFERENCE

This application is based on and claims priority to U.S. Provisional Application No. 63/255,503 filed Oct. 14, 2021.

### BACKGROUND OF THE INVENTION

### Field of the Invention

This invention relates generally to proactive hurricane/typhoon/cyclone mitigation, and more particularly, but not by way of limitation, to an ocean surface structure and its selective placement on the ocean surface, at the path of the Sahara Desert low-pressure trough jet west of the coast of Senegal and Mauritania and at the origin and on the path of tropical storms and hurricanes/typhoons/cyclones with several merits: (1) being proactive by setting up said ocean surface structure(s) at the selected location(s) before the onset of hurricane/typhoon/cyclone season; (2) being cost bearable; (3) being logistically feasible in implementation; (4) being safer and easier to monitor the design and to maintain its operation; and (5) being reversible. Once taming the tropical storm, hurricane, typhoon, and cyclone, the calmer ocean surface may become more suitable for constructing floating solar farms which can better utilize the ocean surface solar irradiance.

### Description of the Related Art

Global warming is expected to increase the numbers per year of tropical storms and hurricanes/typhoons/cyclones, as well as their strength and intensity. Using the Atlantic Ocean region as an example, the United States in 2020 saw a record-setting number of 30 storms, with a top wind speed higher than 39 mph, and 13 of them turned into hurricanes with wind speeds higher than 74 miles/hour.

The number of US residential properties that could be affected by a category 1 hurricane will be over 800,000. For a category 5 hurricane, the number will be over 7,000,000. The estimated insurance loss was approximately $85 billion just for hurricane Katrina alone in 2005, and the moderate insurance loss was approximately $12 billion for hurricane Ivan alone in 2004. So, it is a fair estimate that averagely speaking, the property damage, not including the loss of human lives, associated with tropical storm and hurricane each year will amount to over several tens of billion to over several hundreds of billion just for the United States.

Many mitigation methods or attempts to tame hurricane have been proposed in patents and patent publications. In general, there are three approaches: 1) the after-formation approach - to destroy or to reduce the hurricane’s strength or divert its direction; 2) the semi-proactive approach - to kill the formed tropical low pressure; and 3) the proactive approach - to prevent hurricane formation from happening.

David B. Romanoff (US2010/0264230) proposed using liquid or solid nitrogen to cool the storm by dropping the material into the storm, starting at the top of the storm. Without knowing precisely when the hurricane/typhoon/cyclone will hit, it requires a gigantic raw material inventory buildup and fleets of planes set aside, ready for this mitigation operation. The power of a hurricane/typhoon/cyclone can be equal to that of hundreds of hydrogen bombs, so the amount of liquid or solid nitrogen needed to cool the hurricane/typhoon/cyclone is just colossal. This is a kind of almost impossible for the logistics of the mitigation implementation.

Lawrence Sirovich (US2013/0008365) suggested using submarines provided with bluff-shaped surfaces and/or fins for modification of tropical storms or hurricanes by mixing the upper layer of a section of the body of water with the lower part of the body of water. By coordinating a number of submarines to traverse a region of tropical storm or ahead of the hurricane, the cooled water reduces the amount of heat energy available to fuel the intensity and movement of storms. A typical radius of hurricane/typhoon/cyclone can be approximately 150 miles in radius. This suggestion would require almost all the submarines in the world to participate in this operation.

Boris Feldman (US 2010/0270389) recommended injecting energy-transforming small particles, like snowflakes, into the hurricane to reduce its energy. Manilal J. Salva and Vishal T. Shah (US2010/0072297) suggested flying jet planes with afterburners in the structure. Small changes in temperature on a large scale bring in large changes in other variables on the smaller scale to change the direction and intensity of the hurricane.

Brian P. Sandler (US2008/0047480) suggested using a ship consisting of a lower part with four submersible torpedo-shaped hulls and a V-shaped high part with three fan tubes stacked vertically on each side of the V. The machine was placed in the hurricane eyewall near the hurricane eye. The machine would mechanically blow air from the eyewall to the eye to bend the eyewall and divert into the eye. The machine would slow down the air in the eyewall and the low pressure in the eye would suck the air in. No low pressure equals to no circulation. No circulation equals to no hurricane. This is at best a very dangerous maneuver.

Jeffrey A. Bower etc. (US 8,685,254) proposed a proactive method to mitigate hurricanes. The method is generally described as environmental alteration. The method includes determining a placement of at least one vessel capable of moving water to lower depths in the water via wave-induced downwelling. The method also includes placing the at least one vessel in the determined placement. Further, the method includes generating movement of the water adjacent the surface of the water in response to the placing. By pumping the cooler water from the deeper part of the ocean to the surface and placing the warm water from the ocean surface down to the deeper part of the ocean, the ocean surface water may be cooled to below 26.5° C. so that a tropical storm or hurricane will not occur. The deep water has higher CO₂ concentration and therefore could increase the acidity of sea water. The operation also would require a fleet of vessels and a tremendous big amount of high-speed water pumps. This is a high-cost maneuver.

Although stopping tropical storms or hurricane/typhoon/cyclone from occurring will minimize the casualties associated with the strong winds and heavy rains, rains are critically needed for agriculture, eco-systems, and prevention of forest fire. Consequently, it is desirable to have a storm or hurricane/typhoon/cyclone mitigation method which not only can control the size and strength of storm or hurricane/typhoon/cyclone in a proactive manner, but also, if needed, can reverse the mitigation whenever the mitigation becomes overdone. Since the operation of the mitigation of storm or hurricane/typhoon/cyclone is a daunting task due to the size of this natural power, any operation that requires constant inputs of huge amount of mechanical power and materials will be costly, besides the logistic constraint. Therefore, any approach that uses fixed overhead that can last over 20 years to 40 years without constant, very high inputs of chemicals, energy, fleets of airplanes, or fleets of ships or submarines will be a desirable lower-cost operation

### SUMMARY OF THE INVENTION

In general, this invention relates to selectively setting up vast shields on tropical ocean to minimize sea water from evaporating due to hot sun at the origin locations and along the paths where tropical storms and hurricanes/typhoons/cyclones are often formed. For example, in the Atlantic Ocean, based on the history of tropical storms and hurricanes over the past century, there exist locations where hurricanes most often originate and most common paths of these hurricanes on tropical seas. The tropical storm origin locations on the ocean include, but are not limited to, the vicinity of Cape Verde, both west and south, and their westward paths from the origins to the east of Puerto Rico, Antigua and Barbuda, and Guadeloupe as shown in FIG. 1. The westbound Sahara Desert jet stream will move these storms and hurricanes westward to central America and North America. By proactively setting up the ocean surface structures at the origin locations and along the corridor of the westbound Sahara Desert low pressure jet before the hurricane season, the system allows a proactive approach to tame or mitigate tropical storms and hurricanes. Of cause, from year to year, there are tropical storms and hurricanes/typhoons originated in some particular areas not as expected from our forecasts based on the statistical data. However, adding on additional proactive tropical ocean surface structures at those statistically less likely spots of origins and along their paths will enhance our percent of success in proactively mitigating dangerous tropical storms and hurricanes/typhoons/cyclone year after year.

This vast shield, the ocean surface structure, may include: 1) assemblies of floating object(s) capable of generating cool shade with or without heat insulation properties and/or with or without sunlight reflecting properties and may be capable of allowing moisture condensate, water from high tidal waves, or rain water to drain or to drip down onto the sea; and 2) assemblies of floating boom-like design with or without adiabatic features to insulate the heat from the surrounding warm sea surface water outside of the assembly of boom-like design into the surface water inside the assembly of boom-like design. This boom-like design may also enclose of the floating objects to prevent them from being blown away by the high wind or being purged out of the boom closure by high tide. This boom-like design may also have anchoring, mooring, or dynamic positioning capability, or a combination thereof. Other designs may comprise one or more floating structures with high roofing-like design to escape from the impact of high tidal waves and with low freeboard surfaces to minimize the draft forces by waves and wind. The floater design of a floating structure may be spherical or cylindrical in shape and may be free to rotate upon the impinging force from winds and waves. The rotational energy may be further converted into electrical energy. Tugboat(s) or tugboat-like mover(s) and/or towboat(s) or towboat-like mover(s) can be added to the boom-like structure or floating structure. The boats may comprise GPS and/or DGPS (Differential GPS) for adjusting the position of floating objects and/or floating structures assembles.

By adjusting the percent of surface coverage of the floating objects on targeted ocean surface area, one can adjust the degree of control on tropical storm or hurricane/typhoon/cyclone formation.

These ocean surface structures may be built initially on the ocean surface where the origins of tropical storms and hurricanes/typhoons most often occur. They may also be added on the corridor of the paths to increase the effectiveness of mitigation. They may also be added on the ocean surface, under the path of the low-pressure trough of the Sahara Desert jet, west of Senegal and Mauritania. Then they may be built on the ocean surface where the origins and paths of tropical storms and hurricanes/typhoons/cyclones are secondly likely to occur.

This step-wise construction approach enables mitigating tropical storm and hurricane/typhoon/cyclone in a cost-affordable manner and to progressively lower the percent of damage of tropical cyclones year after year, assuming humans have also gained some control in global warming. This is like the way that human built the ancient Great Wall in China and the city of Rome in Italy. The ocean surface structures can also be more selectively built in their size and location and in their degree control of water evaporation rate so that hurricane/typhoon/cyclone can be tamed in such way only to bring less rain and weaker wind toward inlands and ocean surface constructions.

### BRIEF DESCRIPTION OF THE DRAWINGS

FIG. 1 is a map showing major tropical cyclone zones with origins and paths.

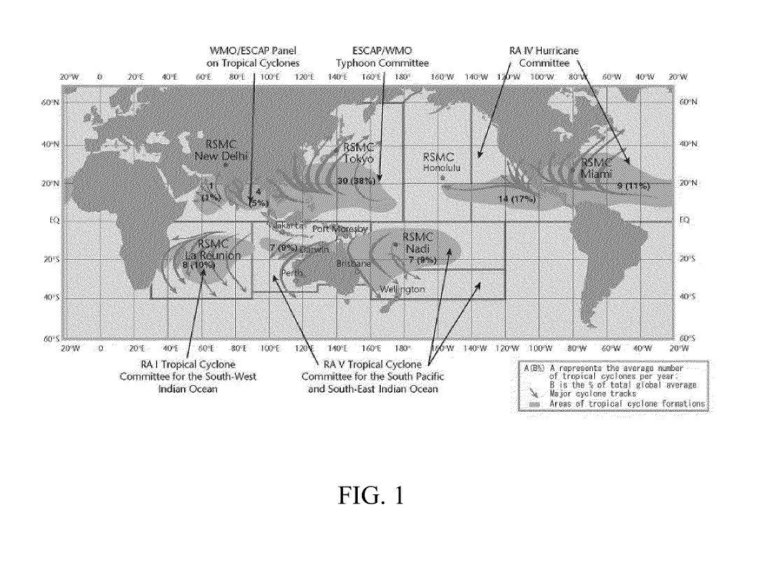

Other advantages and features will be apparent from the following description and from the claims.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to an ocean surface structure designed for mitigating tropical storms and hurricanes/typhoons/cyclones with several merits: 1) being proactive; 2) being cost bearable; 3) being safer and easier to monitor the design and to maintain its operation; 4) being logistically feasible to implement; and 5) being reversible.

For a tropical depression to form, it requires the sea water temperature from 50 meters below and up to the surface to be higher than 26.5 C. It also requires moist air and earth rotation. That is the reason why most of the tropical storms and hurricanes/typhoons/cyclones occur during the summer season. Since we could not stop the earth from rotating, preventing the sea water from being heating up above 26.5 C and minimizing sea water evaporation where the tropical storms and hurricanes/typhoons/cyclones originated most often and along their paths becomes a possible way to prevent them from happening or to mitigate their frequency, strength, and path.

The ocean surface structure discussed herein is merely illustrative of specific design and is not to be interpreted as limiting in scope. While the structure has been described here with a certain degree of particularity, it is to be noted that many modifications may be made in the details of construction and arrangement devices and components without departing from the spirit and scope of this disclosure. It is understood that the structure and components are not limited to the embodiments set forth for purposes of exemplification.

This vast shield, the ocean surface structure, may include: 1) assemblies of floating objects with or without heat insulation properties and/or with or without sunlight reflecting properties, which may be capable of allowing moisture condensate, water from tidal waves, or rain water to drain or to drip down onto the sea; and 2) assemblies of floating boom-like design with or without an adiabatic feature, namely with or without a sunlight reflecting feature to insulate the heat from the surrounding warm sea surface water outside of the assemble of boom-like design into the surface water inside the assemble of boom-like design. This boom-like design may also enclose the floating objects to prevent them from being blown away by the high wind or being purged out of boom enclosure by high tide. This boom-like design may also have anchoring, mooring, or dynamic positioning capability or any combination thereof.

By adjusting the percent of surface coverage of the floating objects, or the percent of surface coverage of hurricane/typhoon/cyclone corridor and path, or both, one can adjust the degree of control on tropical storm or hurricane/typhoon/cyclone formation.

Since these ocean surface structure at the selected locations can be implemented before the onset of the tropical storm and hurricane/typhoon/cyclone season, it significantly reduces the safety risks associated with implementing mitigation operations at around or at the center of eye of the storm or hurricane/typhoon/cyclone. This may also be achieved by setting up the above surface structure near the vicinity of hurricanes/typhoons/cyclones corridor and paths, and then moving this surface structure to within the corridor and paths. This may avoid the head-on collision of the surface structure with the strong wind and high wave of storms or hurricanes/typhoons/cyclones during the setup. It also reduces the high inventory stress associated with raw material and tool supplies. Instead of working to mitigate the storms or hurricanes/typhoons/cyclones in a short duration of weeks after their formation, this invention allows months to years of proactive preparation to mitigate storms or hurricanes/typhoons/cyclones. This may also be achieved by setting up the above-surface structure near the vicinity of the hurricanes/typhoons/cyclones corridor and paths, and then moving this surface structure to within the corridor and paths. This may avoid the head-on collision of the surface structure with the strong wind and high wave of storm or hurricane/typhoon/cyclone during the set up.

Video monitors may be placed to keep an eye on the integrity of the ocean surface structures for security and in-time remedy. Flags and visible night illuminations may also be placed on or nearby the site of the water surface structure for ownership and safety communication to any moving objects like ships or airplanes approaching the water surface structure. Caution signs may also be placed on or nearby the site of the water surface structure for safety.

The ocean surface structures can be built initially on the ocean surfaces at the origins and along the paths where tropical storm and hurricane/typhoon/cyclone most often occur. Then they can be built on the ocean surfaces where the origins and paths of tropical storms and hurricanes/typhoons/cyclones are secondly most often to occur. They can also include on the ocean water, under the path of the low-pressure trough of the Sahara Desert jet, west to the coast of Senegal and Mauritania

It is estimated that these giant ocean shields of sunlight-shielding and/or sunlight-reflecting floating objects and/or floating structures could reflect at most 1% of the total sun irradiation energy onto the tropical seas. Consequently, if the floating objects and/or floating structures not only can minimize sea water from evaporating but also can absorb sun light and turn them into stored electrical energy. This may be a big advantage. The setup of floating ocean surface structure with solar farm may enable the user to supply the total utility energy and electrical vehicle energy needs of the world, achieving cutting the greenhouse gas emission from burning fossil fuels, cooling down the global warming, and also reducing the frequency and the strength of storm and hurricane/typhoon/cyclone.

The floating objects/structures may comprise solar panels, foam materials, plastic materials, rubber materials, bamboo materials, fabric materials, wood materials, other materials obtained from the nature, man-made islands, recycled materials like bottles, metallic materials, or any combinations of the foregoing.

The design of the floating objects/structures may be shaped such that moisture condensate, rain, or sea water impinging upon the object can drain and flow into sea. The shape may allow tight packing of the objects to minimize surface seawater from evaporation and sun energy from heating up the sea water. For example, the objects may comprise urethane foam sheets with or without surface sunlight reflecting materials that can allow rain or sea water draining by its surface contour design. Additionally or alternately, the objects may comprise foam tubes, ping pong balls, basketballs, beach balls, bamboo tubes or sticks, metal drums, plastic drums, wooden barrels, rafts with surface contour for water draining, or any combinations thereof. All materials mentioned shall also include inflatable options if allowed to reduce shipping cost and material cost.

In the case of spherical balls being used, bi-modal or multiple-modal ball sizes may be used to increase the degree of packing tightness. Other floating objects with special shapes designed like Hexaprotect Aqua Tile may also be employed, if with surface contour design for draining. Floating object may also comprise composite material with air as part of the material for floating like balls or with water as filler to increase the density of lightweight objects to avoid them from being blown away. Floating solar panels may comprise tetrahedral structure, polyhedral structure, or spherical structure with micro solar cells for draining purposes.

This step-wise ocean sea water structure construction approach may enable mitigating tropical storm and hurricane/typhoon in a cost-affordable manner and progressively lowering the percent damage of tropical cyclones year after year, assuming humans have gained some control in global warming. This is like the building of the Great Wall or Roman City, as it takes years to accomplish the goal.

Possible locations for the ocean surface structure may include the vicinity of Cape Verde both west (centered around 16.4 N and 27.8 W) and south (centered around 13.3 N and 23.9 W) and the vicinity of ocean surface centered at 21.0°N and 90.0°W north of Merida, Mexico; the vicinity of ocean surface centered at 14°N and 100°W west of Mexico City, Mexico; the vicinity of ocean surface centered at 14.7°N and 137.5°E and the westward typhoon corridor until it reaches Philippines; the vicinity of ocean surface centered at 10°N and 123.8°E west of Iloilo, Philippines; the vicinity of ocean surface centered at 8.0°N and 90.0°E east of Sri Lanka; the vicinity of ocean surface centered at 10.0°N and 71.4°E west of Kochi, India; the vicinity of ocean surface centered at 5.0°S and 152.3°E at Bismarck Sea, the vicinity of ocean surface centered at 9.6°S and 140.0°E at Arafura Sea, or any other desired location comprising the ocean water, under the path of the low-pressure trough of the Sahara Desert jet, west of the coast of Senegal and/or Mauritania.

### Examples

An adiabatic polyethylene plastic water container was used in this study for validating the shield concept. The shield concept is to use one or more floating objects to cover the surface of the water from being heated up by the sun. The floating objects also minimize the water evaporation into the air as measured by the weight loss of water in the container.

Water temperatures were measured by thermocouples, with one at the near bottom of the water and the other one at the near surface of the water, after the uncovered water or water covered with floating object being exposed to sun at high noon for an extended period of time. The high noon was determined by the shape and the position of the shadow of a tree under the sun.

Example 1: A 5.75” x 5.75” adiabatic polyethylene container was placed on a digital balance. The container was loaded with 0.595 lb of warm water (~60 C). The weight loss of water as a function of time was recorded to assess the water evaporation rate, which was related to the warm moist air available for forming tropical hurricane/typhoon. The reason the starting temperature was 60 C was to speed up the water evaporation rate so as to cut down the time needed for this study.

With the surface of the water totally open to the air, about 0.25 lb of water was evaporated in 26 minutes with indoor relative humidity at 56 degrees as shown in Table 1.

TABLE 1

Water Evaporation Rate vs. Surface Coverage by Floating Urethane Foam Tube Insulator

| Water Surface Coverage of Floating Object | Water Weight (lb) | Water Weight Loss (lb) |
|---|---|---|
| 1. > 98% | | |
| Time = 0 min | 0.595 | 0.000 |
| Time = 30 min | 0.585 | 0.010 |
| 2. 0% | | |
| Time = 0 min | 0.595 | 0.000 |
| Time = 26 min | 0.570 | 0.025 |

When the same study was conducted except with a floating urethane foam tube covering greater than 98% of the surface of water, the water evaporation rate dropped to 0.010 lb in 30 minutes. This suggests that if the ocean water surface is covered with floating objects, the sea water evaporation rate can be reduced so is the level of warm moist air above the water. At 25 C, the saturated water vapor pressure is 23.76 mmHg and at 30 C, the saturated water pressure is 31.86 mmHg, which is 1.34 times higher than that at 25 C. The relative water evaporation rate without the urethane foam tube is about 2.5 times of that with the urethane foam tube with water surface coverage at greater than 98%. In an open environment like air above sea water, the surface coverage method is expected to be sufficient to reduce the critical amount of warm moisture needed to aid the formation of storm or hurricane/typhoon/cyclone. The saturated water vapor level at 26.5 C verses that at 25 C shall be lower than 1.34.

Since warm moist air serves like a fuel to aid storm or hurricane/typhoon/cyclone to grow bigger and with faster wind speed, the reduction of this warm moist air by surface coverage structure shall be able to tame the growth of storms or hurricanes/typhoons/cyclones.

Example 2: All these studies below were carried out at the same time to minimize the effect of difference due to sun irradiance, outdoor temperature, wind speed, or humidity. As shown in Table 2, increasing the water surface coverage with floating objects, besides reducing the water evaporation rate, additionally reduced the rate of heating up water by sun irradiation.

TABLE 2

Water Surface Coverage by Floating Urethane Foam vs. Water Heating Up Rate by Sun

| Surface Coverage of Floating Object | Initial Water Temperature (F) | Water Temperature (F) after 1 hour | Water Temperature (F) after 2 hours |
|---|---|---|---|
| 1. 0% | | | |
| Top of Water | 65 | 72 | 74 |
| Bottom of Water | 65 | 69 | 73 |
| 2. 50% | | | |
| Top of Water | 65 | 71 | 73 |
| Bottom of Water | 65 | 68 | 70 |
| 3. 100% | | | |
| Top of Water | 65 | 69 | 69 |
| Bottom of Water | 65 | 66 | 66 |

Example 3: Two adiabatic polyethylene containers were filled, each with 17.70 lb of water. One was 100% covered with a ½” Styron foam sheet and the other was 100% covered with a ½” Styron foam sheet with a top layer of aluminum foil for sun reflection. The heat conductive aluminum foil was not in contact with the water. At high noon, the ambient temperature was 89 F. It was sunny with no wind.

As shown in Table 3, the heat insulating foam with sun reflecting aluminum sheet shows better insulation for water from heating up by hot sun.

TABLE 3

Sun Heating Insulation Comparison between Using Styron Foam Sheet vs. Using Reflecting Aluminum Foil Covered Styron Foam Sheet

| Surface Coverage of Floating Object | Initial Water Temperature (F) | Water Temperature (F) after 1.67 hour |
|---|---|---|
| 1. 100% with ½” Styron Foam Sheet | | |
| Top of Water | 70 | 74 |
| Bottom of Water | 70 | 72 |
| 2. 100% with Aluminum Foil Covered ½” Styron Foam Sheet | | |
| Top of Water | 70 | 72 |
| Bottom of Water | 70 | 71 |

The Sahara Desert jet after leaving the west coast of Africa typically starts to form tropical storms after travelling on the warm water for about 590 miles in hot summer. That was the place at the vicinity of Cape Verde with origins of tropical storm. By setting up the water surface structure at about 100 mi x 300 mi at this specific location, it is expected to damp the formation of tropical storms. As the westward Sahara Desert jet continues to move toward Puerto Rico, the water surface structure can be set up in an interval of every other 350 mi from the first water surface structure, or any other desired interval, to avoid the formation of strong storms or hurricanes.

Example 4: Two adiabatic polyethylene containers were filled, each with 17.70 lb. of water. One was placed under the shade of a 4 ft (wide) x 8 ft (height) solar panel of a photovoltaic system. The solar panel was placed at a 45-degree tilt angle, facing south direct. The other was placed under the sun without any shade. Both are at 4 ft apart. The outdoor temperature was at 97 F with relative humidity at 36 degrees. Minimal wind was detected.

As shown in Table 4, solar panel provided effective sunlight shielding for the water from heating warm. Therefore, at a ridge of a floating platform, for an example, one can place solar panels facing south and water-repellent fabric or sun-reflecting Galvalume sheets, for example, facing north to minimize the sea water from heating up too warm by the hot burning sun. The solar panel based photovoltaic system also converts the solar energy into green electrical energy besides providing cool shade to minimize sea water from heating too warm for hurricane to occur. A floating ocean solar farm can then be set up with ridge after ridge to provide shade over a huge ocean water surface. At low attitude where the hurricane and typhon are most likely to occur, the solar panels can be placed at a tilt angle close to zero on the floating platform.

TABLE 4

The Effect of the Shade of Solar Panel in Shielding the Water from Heating Warm under Hot Sun.

| Surface Coverage of Water by the Shade of Solar Panels | Initial Water Temperature (F) | Water Temperature (F) after 1.67 hour under Sun |
|---|---|---|
| 1. 100% | | |
| Top of Water | 70 | 73 |
| Bottom of Water | 70 | 72 |
| 2. 0% | | |
| Top of Water | 70 | 80 |
| Bottom of Water | 70 | 78 |

In Example 5 below, two adiabatic polyethylene containers were loaded with 122 F warm water. Fabric with elasticity (1.5 mm thick nylon/SBR/nylon) was used to cover the surface of each container. The weight of each container was then monitored for over 24 minutes. As shown in Table 5, fabric shield can reduce the water vapor transmittance rate by about 2.66 times.

Using fabric as a sun shield and as a water vapor barrier material helps the speed in setting up the needed surface structure. The elastic property also provides the structure against the force of ocean swells.

TABLE 5

Effect of Elastic Fabric on Water Evaporation Rate (Room Temperature 70 F; RH = 50 degree; Initial Water Temperature 122 F)

| | Nylon based Elastic Fabric Cover | | No Fabric Cover | |
|---|---|---|---|---|
| | Exp. 1 | Exp. 2 | Exp.1 | Exp.2 |
| Time Required to Lose 0.005 lb | 14 min | 17 min | 6 min | 6 min |
| | Average 16 min ± 2 min | | Average 6 min ± 0 min | |

Whereas, the devices and methods have been described in relation to the drawings and claims, it should be understood that other and further modifications, apart from those shown or suggested herein, may be made within the spirit and scope of this invention.

What is claimed is:

1. A water surface system for mitigation of tropical storms or hurricanes/typhoons/cyclones, the water surface system comprising:
one or more floating objects capable of minimizing water surface temperature increase due to sun irradiation and water evaporation; and
one or more boom-like floating structures and/or one or more tugboats and/or towboats, where the one or more boom-like floating structures and/or one or more tugboats and/or towboats are capable of containing the floating objects in a designated area.

2. The water surface system of claim 1 where the designated area comprises an ocean area under a path of a low-pressure trough of the Sahara Desert jet west of the coast of Senegal and Mauritanian and/or the origins and paths of historically most often occurred storms/hurricanes/typhoons/cyclones.

3. The water surface system of claim 1 where the floating objects have a reflective top surface.

4. The water surface system of claim 1 further comprising one or more visual monitors.

5. The water surface system of claim 1 further comprising one or more flags capable of identifying property ownership.

6. The water surface system of claim 1 further comprising one or more warning devices comprising one or more warning signs, voice warning systems, light warning systems, or a combination thereof.

7. The water surface system of claim 1 further comprising one or more illumination devices.

8. The water surface system of claim 1 further comprising one or more GPS (Global Positioning System) and/or DGPS (Differential Global Positioning System) and AI technologies equipped with one or more cybersecurity protection devices for keeping the water surface system in the designated area.

9. The water surface system of claim 1 further comprsing one or more security guarding stations with security guards with or without at least one drone, where the security guards are capable of patrolling and expelling intruders like animals and pirates.

10. The water surface system of claim 1 where the designated area is a location where tropical storms or hurricanes/typhoons/cyclones are most likely to originate or travel based on tropical storm/hurricane/typhoon/cyclone statistics.

11. The water surface system of claim 1 where the floating objects comprise objects with water draining configurations.

12. The water surface system of claim 1 where the floating objects comprise shade-producing and/or sun-reflecting ocean water surface covers made of foam, metal, fabric, plastic, thermoplastic, fiberglass, thermoset material, rubber, asphalt, carbon fiber, bamboo, wood, ceramic, composite material, solar panels, natural products, or any combination thereof.

13. The water surface system of claim 1 where the floating objects comprise tubes, balls, sticks, trunks, drums, barrels, sheets, inflatable sheets, mats, inflatable mats, rafts, inflatable rafts, screen wires, floating decks, floating photovoltaic systems, boats, ships, floating decks, or a combination thereof.

14. The water surface system of claim 9 where the floating objects comprise bi-modal spheric balls or multi-modal spheric balls.

15. The water surface system of claim 1 where the floating objects comprise hollow foam tubes with filler, hollow foam tubes without filler, hollow boxes of any shape with filler, hollow boxes of any shape without filler, or a combination thereof.

16. The water surface system of claim 1 where the floating objects comprise algae.

17. The water surface system of claim 1 where the floating objects are capable of reversibly interlocking in part or in whole.

18. The water surface system of claim 1 where the boom-like floating structures are capable of reversibly interlocking in part or in whole.

19. The water surface system of claim 1 where the floating objects and the boom-like floating structures are capable of reversibly interlocking in part or in whole.

20. The water surface system of claim 1 further comprising anchoring, mooring, or dynamic positioning devices, or any combination thereof, connected to the boom-like floating structures.

21. The water surface system of claim 1 further comprising one or more tugboats and/or towboats connected to the boom-like floating structures.

22. The water surface system of claim 1 further comprising one or more pumps capable of pumping cool water from a deep level of tropical ocean and spraying the cool water around an ocean surface located in the designated area.

23. The water surface system of claim 22 further comprising one or more fleets of giant ships housing the water pumps and with one or more cool water storage structures and fleets with water storage capable of drawing the cool water from the fleets with cool water storage structures and high-power water cannons capable of spraying the cool water around the designated area.

24. The water surface system of claim 22 where the pumps are located in between two adjacent surface water systems, west of a water surface system, east of a water surface system, or a combination thereof.

25. The water surface system of claim 1 further comprising:
photovoltaic systems on the floating objects and/or boom like floating structures; and
one or more electrical cables capable of connecting the photovoltaic systems to at least one electrical power grid.

26. The water surface system of claim 1 further comprising:
photovoltaic systems on the floating objects and/or boom like floating structures; and
one or more container ships with photovoltaic generators capable of storing electrical energy generated from photovoltaic systems.

27. The water surface system of claim 1 further comprising one or more waterways capable of dividing the floating structure to make way for ship traffic and for ease of maintenance of the water surface system.

28. The water surface system of claim 1 further comprising one or more surface floats capable of generating electrical energy through force of ocean swells.

29. The water surface system of claim 1 where the boom-like floating structures comprise floaters connected with nets capable of preventing the floating objects from leaving the designated areas and reducing the freeboard of the boom-like floating structures.

30. The water surface system of claim 1 where the floating structures comprise at least one robot capable of cleaning dust and bird droppings routinely as needed.

31. The water surface system of claim 6 where the voice warning system comprises sounds capable of scaring birds away.

32. The water surface system of claim 17 further comprising tools capable of reversibly interlocking the floating objects in whole or in part, where the tools comprise elastic materials.

33. The water surface system of claim 32 where the elastic materials comprise coils, bands, buckles, or any combination thereof.

34. The water surface system of claim 18 further comprising tools capable of reversibly interlocking the boom-like floating objects in whole or in part, where the tools comprise elastic materials.

35. The water surface system of claim 34 where the elastic materials comprise coils, bands, buckles, or any combination thereof.

36. The water surface system of claim 1 where the system is capable of being built out of the designated area to avoid a head-on encounter with storms/hurricanes/typhoons/cyclones during construction and then moved into the designated area.

37. The water surface system of claim 1 further comprising at least one lightening rod.

38. The water surface system of claim 1 where the floating structures comprise at least one drone equipped with at least one visual and/or thermal camera capable of detecting damage to solar panels and intruders like birds, sea animals, and pirates.

39. The water surface system of claim 1 where the system is capable of being built off he designated area to avoid an encounter with a storm or hurricane/typhoon/cyclone during construction and then moved into the designated area.

40. The water surface system of claim 13 where the photovoltaic system comprises solar panels treated with slippery coatings as water repellent and for water and dust to easily glide off the solar panel surface.

41. A method of harvesting solar energy at high solar irradiance areas on sea, the method comprising:
setting up a water surface system to minimize threats from strong winds and high waves, the water surface system comprising:
one or more floating objects capable of minimizing water surface temperature increase due to sun irradiation and water evaporation; and
one or more boom-like floating structures and/or one or more tugboats and/or tugboat-like movers and/or towboats and/or towboat-like movers, where the one or more boom-like floating structures and/or one or more tugboats and/or tugboat-like movers and/or towboats and/or towboat-like movers are capable of containing the floating objects in a designated area; and
setting up a floating solar farm on water of high solar irradiance to harvest solar energy and to transmit the harvested solar energy through inverters to electric cables connected to power grids and/or by at least one ship with storage batteries to power grids through inverters.

42. The method of claim 41 where high solar irradiance is 3.0 kWh/m² or higher.

43. The method of claim 42 where the solar panels of the solar farm are treated with slippery coatings as water repellent and for water and dust to easily glide off the solar panel surface.
